(19) United States
(12) Patent Application Publication
(10) Pub. No.: US 2025/0079876 A1
(43) Pub. Date: Mar. 6, 2025

(54) POWER SUPPLY CIRCUIT AND ELECTRONIC DEVICE

(71) Applicant: Ninebot (Changzhou) Tech Co., Ltd., Changzhou (CN)

(72) Inventors: Ziyang LIN, Changzhou (CN); Zeyong LIU, Changzhou (CN)

(21) Appl. No.: 18/749,426

(22) Filed: Jun. 20, 2024

(30) Foreign Application Priority Data
Aug. 31, 2023 (CN) 202311121620.6

(51) Int. Cl. H02J 7/34; H01M 10/42; H01M 10/48; H01M 50/512; H02J 7/00

(52) U.S. Cl. CPC H02J 7/34; H01M 10/425; H01M 10/48; H01M 50/512; H02J 7/0013; H02J 7/0036; H02J 7/0063

(57) ABSTRACT

A power supply circuit and an electronic device are provided. The power supply circuit and the electronic device include at least one sub power supply circuit, each sub power supply circuit includes two battery modules, a processing module, and a switch module corresponding to each battery module; an output end of the battery module is connected to one end of a corresponding switch module and one end of the processing module, respectively; the other end of the switch module is connected to a load, and the other end of the processing module is connected to a control end of the switch module; and the processing module is configured to control, based on a voltage difference between the battery modules, the switch module of one of the battery modules or the switch modules of the two battery modules to be closed, in order to supply power to the load.

### CROSS-REFERENCE TO RELATED DISCLOSURES

This disclosure claims priority to Chinese Patent Disclosure No. 202311121620.6, filed on Aug. 31, 2023, which is hereby incorporated by reference in its entirety.

### TECHNICAL FIELD

The present disclosure relates to a technical field of control circuits and, in particular, to a power supply circuit and an electronic device.

### BACKGROUND

A dual-battery power supply refers to two batteries connected in parallel to form a common circuit for supplying power to a device. The dual-battery power supply enables a device to operate for longer periods of time and provides a better current output capability. When the device requires a relatively large current, the dual-battery power supply can meet the demand, so as to avoid the abnormal operation or damage of the device due to an insufficient current. However, an existing dual power supply circuit has problems with low stability and circuit complexity.

Therefore, how to improve the stability of the dual-power supply circuit and reduce the circuit complexity are urgent problems that need to be solved.

### SUMMARY

The present disclosure provides a power supply circuit and an electronic device, which are used to solve existing problems of improving the stability of the dual power supply circuit and reducing circuit complexity.

On the first hand, the present disclosure provides a power supply circuit, the power supply circuit includes at least one sub power supply circuit, each sub power supply circuit includes two battery modules, a processing module, and a switch module corresponding to each battery module;
an output end of the battery module is connected to one end of a corresponding switch module and one end of the processing module, respectively; the other end of the switch module is connected to a load, and the other end of the processing module is connected to a control end of the switch module; and
the processing module is configured to control, based on a voltage difference between the battery modules, the switch module of one of the battery modules or the switch modules of the two battery modules to be closed, in order to supply power to the load.

In an implementation, the processing module includes: a logic processing unit, an operation unit corresponding to each battery module, and a comparison unit;
an input end of the operation unit is connected to output ends of the two battery modules, respectively; an output end of the operation unit is connected to an input end of a corresponding comparison unit, and an output end of the comparison unit is connected to an input end of the logic processing unit;
the operation unit is configured to obtain the voltage difference between the battery modules;
the comparison unit is configured to judge a magnitude relationship between the voltage difference of the battery modules and a preset threshold; and
the logic processing unit is configured to control, based on the magnitude relationship between the voltage difference of the battery modules and the preset threshold, the switch module of one of the battery modules or the switch modules of the two battery modules to be closed, in order to supply power to the load.

In an implementation, the operation unit includes a first resistor, a second resistor, a third resistor, a fourth resistor, and an operational amplifier;
a first end of the first resistor is connected to an output end of a battery module corresponding to the operation unit, and a second end of the first resistor is connected to a negative pin of the operational amplifier and a first end of the fourth resistor, respectively; a first end of the second resistor is connected to an output end of the other battery module, a second end of the second resistor is connected to a positive pin of the operational amplifier and a first end of the third resistor, respectively; a second end of the third resistor is grounded; a second end of the fourth resistor is connected to an output end of the operational amplifier; an anode of a power supply end of the operational amplifier is connected to an output end of a first power supply, and a cathode of the power supply end of the operational amplifier is grounded;
the operational amplifier is configured to obtain the voltage difference between the battery modules based on output voltages of the battery modules; and
the fourth resistor is configured to form a feedback resistor for the operation unit.

In an implementation, the comparison unit includes a fifth resistor, a sixth resistor, a first comparator, and a second comparator;
a first end of the fifth resistor and a first end of the sixth resistor are connected to an output end of an operational amplifier, respectively; a second end of the fifth resistor is connected to a positive pin of the first comparator, a negative pin of the first comparator is connected to an output end of a second power supply, an output end of the first comparator is connected to an input end of the logic processing unit; a second end of the sixth resistor is connected to a negative pin of the second comparator, a positive pin of the second comparator is connected to the output end of the second power supply, and an output end of the second comparator is connected to the input end of the logic processing unit;
the first comparator is configured to output a high level when a voltage difference output by the operational amplifier is higher than or equal to a reference voltage output by the second power supply; and
the second comparator is configured to output a high level when the voltage difference output by the operational amplifier is lower than the reference voltage output by the second power supply.

In an implementation, the logic processing unit includes an AND gate subunit and two OR gate subunits;
an input end of the AND gate subunit is connected to two second comparators, respectively; an output end of the AND gate subunit is connected to input ends of the two OR gate subunits, respectively;
the AND gate subunit is configured to output a high level when the voltage difference is lower than a reference voltage, and output a low level when the voltage difference is higher than the reference voltage;
the OR gate subunit is configured to output a high level when a voltage of a corresponding battery module is higher than a voltage of the other battery module, and output a low level when the voltage of the corresponding battery module is lower than the voltage of the other battery module.

In an implementation, the switch module includes a first electronic switch, a second electronic switch, a third electronic switch, a seventh resistor, an eighth resistor, a ninth resistor, and a first capacitor;
a first end of the seventh resistor is connected to an output end of the logic processing unit, a second end of the seventh resistor is connected to a first pole of the first electronic switch and a first end of the first capacitor, respectively; a second pole of the first electronic switch is grounded, and a third pole of the first electronic switch is connected to a first end of the eighth resistor; a second end of the eighth resistor is connected to a first pole of the second electronic switch, a first pole of the third electronic switch, and a first end of the ninth resistor, respectively; a second end of the ninth resistor is connected to a second pole of the second electronic switch and a third pole of the third electronic switch, respectively; a third pole of the second electronic switch is connected to the output end of the battery module, and a second pole of the third electronic switch is connected to the load;
the first electronic switch is configured to be disconnected or closed based on an enabling signal output by the logic processing unit, and when the first electronic switch is closed, the power is supplied to the load through the second pole of the third electronic switch.

In an implementation, the electronic switch is a MOS transistor, a first pole of the electronic switch is a gate of the MOS transistor, a second pole of the electronic switch is a drain of the MOS transistor, and a third pole of the electronic switch is a source of the MOS transistor.

In an implementation, the power supply circuit further includes two battery in-place detection switches;
a first end of the battery in-place detection switch is connected to an output end of a corresponding battery module, and a second end of the battery in-place detection switch is connected to input ends of two operation units, respectively; and
the battery in-place detection switch is configured to detect whether the corresponding battery module is in place, wherein the battery in-place detection switch is closed when the corresponding battery module is in place, and the battery in-place detection switch is disconnected when the corresponding battery module is not in place.

In an implementation, the power supply circuit further includes two power supply in-place detection switches;
a first end of the power supply in-place detection switch is connected to an output end of the logic processing unit, and a second end of the power supply in-place detection switch is connected to a control end of a corresponding switch module;
the power supply in-place detection switch is configured to be disconnected when a third power supply for charging the corresponding battery module is plugged in, and the power supply in-place detection switch is configured to be closed when the corresponding battery module does not detect that the third power supply is plugged in.

On the second hand, the present disclosure provides an electronic device, which includes the power supply circuit as described in any one of the first hand.

According to the power supply circuit and electronic device provided in the present disclosure, the switch module of one of the battery modules is controlled to close or the switch modules of the two battery modules are controlled to be closed by the processing module based on the voltage difference between the two battery modules, in order to achieve the function of supplying power to the load with a battery or dual batteries. When the voltage difference between the two battery modules is large, only the battery module with a higher voltage is configured to supply power; when the voltage difference is lower than the preset threshold, the two battery modules are configured to supply power, thereby improving the working time and current demands of the device, as well as improving a voltage stability and reducing power loss and cost. Besides, there are no restrictions on cell parameters and a protocol of the battery, so the solution has an advantage of strong compatibility.

### BRIEF DESCRIPTION OF DRAWINGS

To describe the technical solutions in embodiments of the present disclosure or in the prior art more clearly, the following briefly introduces the accompanying drawings needed for describing the embodiments or the prior art. Apparently, the accompanying drawings in the following description illustrate merely some embodiments of the present disclosure, and persons of ordinary skill in the art may still derive other drawings from these accompanying drawings without paying creative effort.

FIG. 1 is a schematic structural diagram of a power supply circuit provided in an embodiment of the present disclosure.

FIG. 2 is a schematic structural diagram of another power supply circuit provided in an embodiment of the present disclosure.

FIG. 3 is a schematic structural diagram of still another power supply circuit provided in an embodiment of the present disclosure.

FIG. 4 is a schematic structural diagram of yet another power supply circuit provided in an embodiment of the present disclosure.

FIG. 5 is a schematic structural diagram of yet another power supply circuit provided in an embodiment of the present disclosure.

FIG. 6 is a schematic structural diagram of yet another power supply circuit provided in an embodiment of the present disclosure.

FIG. 7 is a schematic structural diagram of yet another power supply circuit provided in an embodiment of the present disclosure.

FIG. 8 is a schematic structural diagram of a battery in-place detection switch provided in an embodiment of the present disclosure.

FIG. 9 is a schematic structural diagram of yet another power supply circuit provided in an embodiment of the present disclosure.

FIG. 10 is a schematic structural diagram of yet another power supply circuit provided in an embodiment of the present disclosure.

Reference signs:

| | |
|---|---|
| 100-Battery module | 200-Processing module |
| 300-Switch module | 201-Logic processing unit |
| 202-Operation unit | 203-Comparison unit |
| R1-First resistor | R2-Second resistor |
| R3-Third resistor | R4-Fourth resistor |
| OP777-Operational amplifier | R5-Fifth resistor |
| R6-Sixth resistor | LT1-First comparator |
| LT2-Second comparator | A1-AND gate subunit |
| B1-OR gate subunit | D1-First diode |
| D2-Second diode | M1-First MOS transistor |
| M2-Second MOS transistor | M3-Third MOS transistor |
| R7-seventh resistor | R8-Eighth resistor |
| R9-Ninth resistor | C1-First capacitor |
| V2-Second power supply | R10-Tenth resistor |
| R11-Eleventh resistor | |
| E1-Battery in-place detection switch | |
| E2-Power supply in-place detection switch | |

Through the above drawings, specific embodiments of the present disclosure have been shown, and more detailed descriptions will be provided in the following text. These drawings and descriptions in words are not intended to limit the scope of the concept of the present disclosure in any way, but rather to illustrate the concept of the present disclosure to those skilled in the art by referring to specific embodiments.

### DESCRIPTION OF EMBODIMENTS

To make the purpose, technical solution, and advantages of the present disclosure clearer, further detailed descriptions of embodiments of the present disclosure will be provided below in conjunction with the accompanying drawings.

It should be clarified that the described embodiments are only a portion of the embodiments of the present disclosure, and not all of them. Based on the embodiments in the present disclosure, all other embodiments obtained by those with ordinary skills in the art without paying creative labor fall within the protection scope of the present disclosure.

When the following descriptions involve drawings, unless otherwise indicated, the same numbers in different drawings represent the same or similar elements. The embodiments described in the following exemplary embodiments do not represent all embodiments consistent with the present disclosure. On the contrary, they are only examples of apparatuses and methods that are consistent with some aspects of the present disclosure as detailed in the attached claims.

In the description of the present disclosure, it should be understood that the terms “first”, “second”, “third”, etc. are only used to distinguish similar objects and do not need to be used to describe a specific order or sequence, nor can they be understood as indicating or implying relative importance. For those with ordinary skills in the art, the specific meanings of the above terms in the present disclosure can be understood based on specific circumstances. Furthermore, in the description of the present disclosure, unless otherwise specified, “multiple” refers to two or more. “And/or” describes the association relationship of the associated object, indicating that there can be three types of relationships, such as A and/or B, which can represent: A exists alone, A and B exist simultaneously, and B exists alone. The character “/” generally indicates that the associated object is an “or” relationship.

At present, techniques of supplying power with parallel batteries are mainly achieved through the following three methods.

Method 1: manually measure a voltage of each battery through a voltmeter, and connect batteries with similar voltages in parallel. For example, battery 1 (199 mV) and battery 2 (201 mV) that are both close to 200 mV can be connected in parallel to form a dual battery power supply module.

However, there is an issue of inaccurate measurement results when manually measuring the voltages of batteries that need to be connected in parallel, thus resulting in a large voltage difference between the two batteries and unstable power supply.

Method 2: connect in parallel through diodes, insulate-gate bipolar transistors (Insulate-Gate Bipolar Transistor, IGBTs), or thyristors, etc. Take diodes as an example, due to the unidirectional conductivity of the diode, when anodes of two batteries are connected together through the diode, if a voltage difference between the anode and a cathode of the diode is higher than a forward voltage drop of the diode, the diode will become conductive, to form a low impedance path between the anodes of the two batteries, a current can flow from the battery where the anode of the diode is located to the battery where the cathode of the diode is located. When the voltage of the battery connected to the cathode of the diode is higher than the voltage of the battery connected to the anode of the diode, the diode will be in a reverse bias state, to prevent the current from flowing from the cathode of the diode to the anode of the diode, thereby avoiding the interconnection between the two and reducing the problem of unstable power supply.

However, when two batteries are connected in parallel through the diode, if the voltage is relatively low and the voltage difference between the anode and the cathode of the diode is higher than the forward voltage-drop voltage of the diode (such as 0.7V), the diode becomes conductive and the current flows from the anode to the cathode, at this time, the diode will have a power loss of 0.7V*current. The higher the current, the greater the power loss of the diode. Besides, there is also significant power loss when parallel connection is realized through the IGBT or the thyristor.

Method 3: control an output voltage of two batteries through a control logic of a battery management system (BMS) to achieve a dual battery power supply solution with a high stability. However, in this implementation, the system complexity and cost are high, and the solution must be achieved through a BMS in consistent with cell parameters and a protocol of the battery, and thus has high limitations.

In view of this, the present disclosure provides a power supply circuit. Multiple batteries are connected through basic electronic components such as resistor(s), capacitor(s), diode(s), switch(es), and comparator(s), and a voltage difference of the multiple batteries is detected, in this way, automatic scheduling of parallel power supply using the multiple batteries is achieved, thereby improving the working time and current demands of the device, as well as improving a voltage stability and reducing power loss and cost. Besides, there are no restrictions on cell parameters and a protocol of the battery, so the solution has an advantage of strong compatibility.

Below are specific embodiments to provide a detailed explanation of the technical solutions of the present disclosure and how they solve the above-mentioned technical problems. The following specific embodiments can be combined with each other, and similar concepts or processes may not be repeated in some embodiments. In the following, the embodiments of the present disclosure will be described in conjunction with the accompanying drawings.

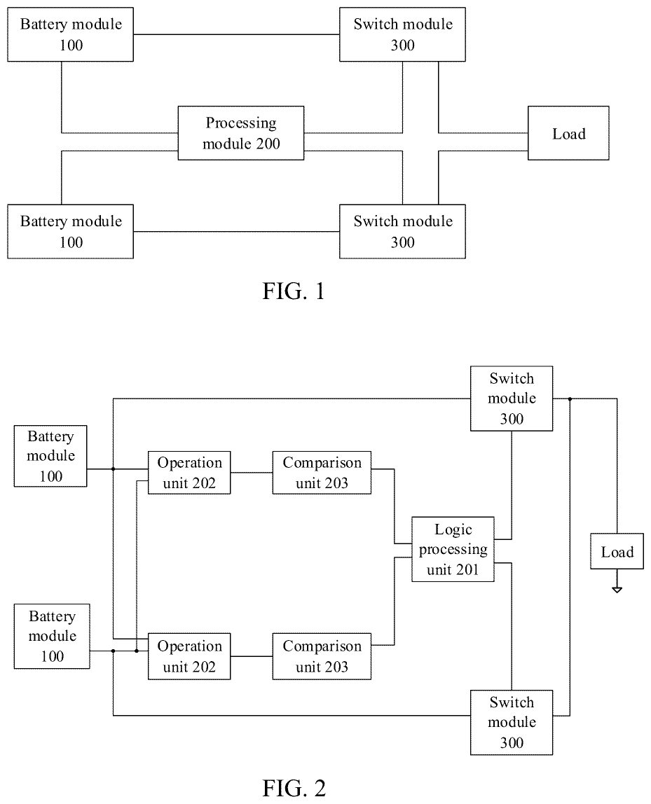

FIG. 1 is a schematic structural diagram of a power supply circuit provided in an embodiment of the present disclosure. As shown in FIG. 1, the power supply circuit includes at least one sub power supply circuit, each sub power supply circuit includes two battery modules 100, a processing module 200, and a switch module 300 corresponding to each battery module 100.

Among them, an output end of the battery module 100 is connected to one end of a corresponding switch module 300 and one end of the processing module 200, respectively. The other end of the switch module 300 is connected to a load, and the other end of the processing module 200 is connected to a control end of the switch module 300.

The battery module 100 can be a battery, a battery component, a battery pack, etc. The battery can be, for example, a lithium battery, zinc manganese battery, fuel cell, bromine hydrogen battery, etc. The switch module 300 is a switch module 300 that can be disconnected and closed based on an enabling signal, for example, it can be a switch module 300 composed of a N-Metal-Oxide-Semiconductor (NMOS) electronic switch, a P-Metal-Oxide-Semiconductor (PMOS) electronic switch, or a transistor, etc. The other end of the processing module 200 includes two output ends, one output end is connected to the switch module 300 corresponding to a first battery module 100, and the other output end is connected to the switch module 300 corresponding to the other battery module 100.

The processing module 200 is configured to control the switch module 300 of one of the battery modules 100 or the switch modules 300 of the two battery modules 100 to be closed, based on a voltage difference between the battery modules 100, in order to supply power to the load.

Among them, an output end of the processing module 200 is connected to a control end of the switch module 300, to control the disconnecting and closing of the switch module 300 by outputting an enabling signal. The processing module 200 calculates the voltage difference between the two battery modules 100 based on the output voltages of the two battery modules 100, and determines whether to output an enabling signal based on a value of the voltage difference. If the voltage difference is lower than a preset threshold, the processing module 200 outputs an enabling signal that can make the two switch modules 300 closed. If the voltage difference is higher than or equal to the preset threshold, the processing module 200 simply outputs an enabling signal which can make the switch module 300 corresponding to the battery module 100 with a higher voltage closed.

When the output end of the processing module 200 outputs an enabling signal for closing a switch module 300 that receives the enabling signal, so that a power supply loop of the battery module 100 corresponding to said switch module 300 becomes conductive, and power is supplied to the load. The load can be electronic device(s), electric motor(s), light bulb(s), heater(s), resistor(s), capacitor(s), inductor(s), etc. Exemplarily, it can be, for example, electronic device(s) such as computer(s), monitor(s), printer(s), etc., or lighting fixture(s) such as incandescent lamp(s), fluorescent lamp(s), LED light(s), etc., or electric motor(s) for electric fan(s), washing machine(s), refrigerator(s), etc.

When the number of sub power supply circuits included in the power supply circuit exceeds one, the power supply circuit can be achieved through the following implementations.

One possible implementation is that each sub power supply circuit is connected in parallel with the load, and the sub power supply circuits supply power to the load separately. When there is a sub power supply circuit supplying power to the load, loop/loops of other sub power supply circuit/circuits is/are disconnected to stop supplying power to the load.

Another possible implementation is to take each sub power supply circuit as a battery module 100, and each two sub power supply circuits are connected to and connected through the processing module 200 to the switch modules 300 corresponding to respective sub power supply circuits. One end of the sub power supply circuit connected to the load serves as the output end of the battery module 100 and is connected to the processing module 200 and the switch module 300. In this implementation, the power supply circuit may include a multi-layer structure, for example, 16 batteries, a first layer includes 16 battery modules 100 and 8 sub power supply circuits; a second layer includes 8 battery modules 100 and 4 sub power supply circuits, where 8 sub power supply circuits are taken as the battery module 100; and so on. The power supply circuit includes a total of 4 layers and 16 batteries for power supply.

According to the structure provided in the present disclosure, the switch module 300 of one of the battery modules 100 is controlled to be closed or the switch modules 300 of the two battery modules 100 are controlled to be closed by the processing module 200 based on the voltage difference between two battery modules 100, in order to achieve the function of supplying power to the load with a single battery or dual batteries. When the voltage difference between the dual battery modules 100 is relatively large, only the battery module 100 with a higher voltage is used to supply power; when the voltage difference is lower than the preset threshold, the dual battery modules 100 are used to supply power, thereby improving the working time and current demands of a device, as well as improving a voltage stability and reducing the power loss and cost. Besides, there are no restrictions on cell parameters and a protocol of the battery, so the solution has an advantage of strong compatibility.

Below, a detailed introduction is provided for describing a circuit structure of the processing module 200.

FIG. 2 is a schematic structural diagram of another power supply circuit provided in the embodiment of the present disclosure. As shown in FIG. 2, the power supply circuit is based on the circuit structure shown in FIG. 1, and the processing module 200 includes a logic processing unit 201, an operation unit 202 corresponding to each battery module 100, and a comparison unit 203.

Among them, an input end of the operation unit 202 is connected to output ends of the two battery modules 100, respectively; an output end of the operation unit 202 is connected to an input end of a corresponding comparison unit 203, and an output end of the comparison unit 203 is connected to an input end of the logic processing unit 201.

The operation unit 202 is configured to obtain the voltage difference between the battery modules 100. The operation unit 202, for example, can be any type of subtraction operation circuit, for example, a differential operation circuit. The operation unit 202 includes two input ends, one input end is connected to an output end of the battery module 100, and the other input end is connected to an input end of the other battery module 100. The output end of the operation unit 202 is a difference in voltage between the two battery modules 100, namely the voltage difference. When the difference in voltage between the two battery modules 100 is positive, for example, if the operation unit 202 is configured to calculate the difference of the voltage of the battery 1 minus the voltage of the battery 2, when the voltage of the battery 1 is higher than that of the battery 2, the difference is positive, then an output of the operation unit 202 is 1; when the difference in voltage between the two battery modules 100 is negative, for example, if the operation unit 202 is configured to calculate the difference of the voltage of the battery 1 minus the voltage of the battery 2, and the voltage of the battery 1 is lower than that of the battery 2, the difference is negative, then the output of the operation unit 202 is 0.

The comparison unit 203 is configured to judge a magnitude relationship between the voltage difference of the battery modules 100 and a preset threshold. The comparison unit 203, for example, can be a comparison circuit formed by a comparator, the comparator can be any existing comparator electronic component, which is not limited in the present disclosure. The comparison unit 203 can determine the magnitude relationship between the preset threshold and the voltage difference between the battery modules 100 by comparing the voltage difference with a reference voltage. The reference voltage can be set based on the preset threshold, for example, if the preset threshold is 2 mV, the reference voltage is 2 mV. The comparison unit 203 outputs a low level when the voltage difference is higher than the preset threshold, and a high level when the voltage difference is lower than or equal to the preset threshold.

The logic processing unit 201 is configured to control the switch module 300 of one of the battery modules 100 or the switch modules 300 of the two battery modules 100 to be closed, based on a relationship between the voltage difference of the battery modules 100 and the preset threshold, in order to supply the power to the load. When the voltage difference is higher than or equal to the preset threshold, the logic processing unit 201 outputs an enabling signal to the switch module 300 corresponding to the battery module 100 with a higher voltage to make the switch module 300 closed, thus making the power supply circuit of the battery module 100 with the higher voltage conductive, to supply power to the load; when the voltage difference is lower than the preset threshold, the logic processing unit 201 respectively outputs enabling signals to the switch modules 300 corresponding to the two battery modules 100, to make the two switch modules 300 closed, thereby making the power supply circuits of the two battery modules 100 conductive, to supply power to the load through the two battery modules 100.

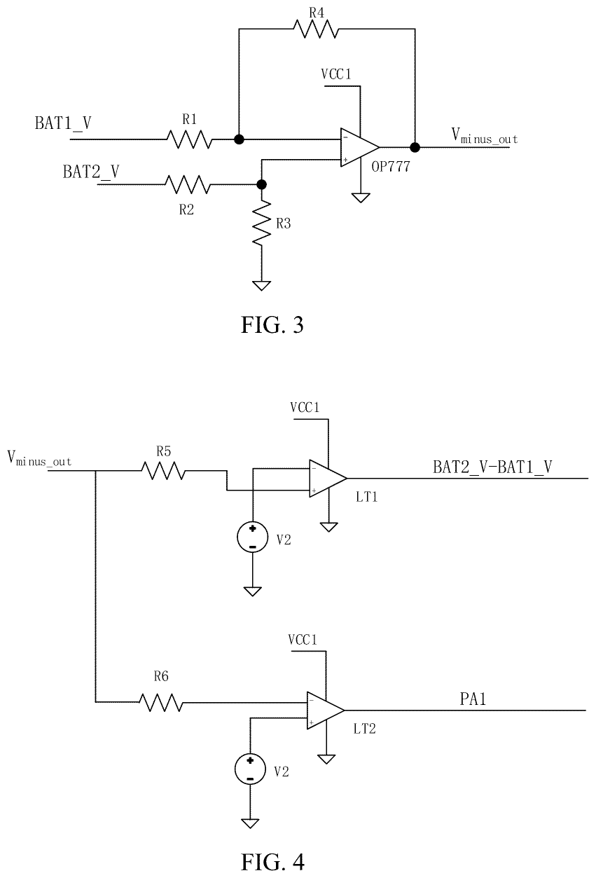

Below, a detailed introduction is provided for describing a specific circuit structure of the above-mentioned operation unit 202. FIG. 3 is a schematic structural diagram of still another power supply circuit provided in the embodiment of the present disclosure. As shown in FIG. 3, the power supply circuit is based on the circuit structure shown in FIG. 2, the operation unit 202 includes: a first resistor R1, a second resistor R2, a third resistor R3, a fourth resistor R4, and an operational amplifier OP777.

Among them, a first end of the first resistor R1 is connected to the output end of the battery module 100 corresponding to the operation unit 202, and a second end of the first resistor R1 is connected to a negative pin of the operational amplifier OP777 and a first end of the fourth resistor R4, respectively; a first end of the second resistor R2 is connected to the output end of the other battery module 100, a second end of the second resistor R2 is connected to a positive pin of the operational amplifier OP777 and a first end of the third resistor R3, respectively; a second end of the third resistor R3 is grounded; a second end of the fourth resistor R4 is connected to an output end of the operational amplifier OP777; an anode of a power supply end of the operational amplifier OP777 is connected to an output end of a first power supply, and a cathode of the power supply end of the operational amplifier OP777 is grounded. Where resistance values of the first resistor R1 and the second resistor R2 are the same, and resistance values of the third resistor R3 and the fourth resistor R4 are the same.

The operational amplifier OP777 is configured to obtain the voltage difference between the two battery modules 100 based on output voltages of the battery modules 100. The battery module 100 corresponding to the operation unit 202 is connected to an inverting output end of the operational amplifier OP777; and the other battery module 100 is connected to an in-phase output end of the operational amplifier OP777. The first resistor R1 is configured to divide the voltage output by the battery module 100 corresponding to the operation unit 202, the second resistor R2 and the third resistor R3 are used to divide the voltage output by the other battery module 100. The fourth resistor R4 is configured to form a feedback resistor for the operation unit 202.

A differential operation circuit is formed by using the above connection manner and the superposition principle. The differential operation circuit can obtain the voltage difference of the two battery modules 100 and amplify the voltage difference. For example, an example is taken where the above battery module 100 corresponding to the operation unit 202 is the battery 1 and the other battery module 100 is the battery 2, the output of the operational amplifier OP777 can be shown in Equation (1) as follows:

$${V}_{minus \_ out} = ( BAT2\_V - BAT1\_V ) \times \frac{r 4}{r 3} . \qquad ( 1 )$$

Among them, V_{minus_out} is an amplified voltage difference, BAT2_V is an output voltage of the battery 2, BAT1_V is an output voltage of the battery 1, r4 is a resistance value of the fourth resistor R4, and r3 is a resistance value of the third resistor R3. When the output voltage of the battery 2 is higher than the output voltage of the battery 1, V_{minus_out} is positive. When the output voltage of the battery 1 is higher than the output voltage of the battery 2, V_{minus_out} is 0.

The resistance values of the third resistor R3 and the fourth resistor R4 can be determined based on an amplification factor required for the voltage difference, which can be determined according to actual requirements and is not limited in the present disclosure. The amplification of this voltage difference would be beneficial for setting a reference voltage by the subsequent comparison unit 203 and improving the accuracy of controlling this voltage difference.

Similarly, in the operation unit 202 corresponding to the other battery module 100, continually take the battery 1 and the battery 2 as examples, the above battery module 100 corresponding to the operation unit 202 is the battery 2, and the other battery module 100 is the battery 1. The output of the operational amplifier OP777 can be shown in equation (2) as follows:

$${V}_{u 1 \_ minus \_ out} = ( BAT1\_V - BAT2\_V ) \times \frac{r 4}{r 3} . \qquad ( 2 )$$

In this case, only the positions of the positive pin and the negative pin of the operational amplifier OP777 connected to the battery 1 and the battery 2 are swapped, and V_{u1_minus_out} represents the enlarged value of the voltage difference between the battery 1 and the battery 2.

The above FIG. 3 only illustrates the operation unit 202 where V_{minus_out} is located. The operation unit 202 where V_{u1_minus_out} is located is similar to that of said operation unit 202, which will not be repeated here.

Below, a detailed introduction is provided for describing the specific circuit structure of the above comparison unit 203. FIG. 4 is a schematic structural diagram of yet another power supply circuit provided in the embodiment of the present disclosure. As shown in FIG. 4, the power supply circuit is based on the circuit structure shown in FIG. 2, and the comparison unit 203 includes: a fifth resistor R5, a sixth resistor R6, a first comparator LT1, and a second comparator LT2.

Among them, a first end of the fifth resistor R5 and a first end of the sixth resistor R6 are connected to the output end of the operational amplifier OP777, respectively; a second end of the fifth resistor R5 is connected to a positive pin of the first comparator LT1, a negative pin of the first comparator LT1 is connected to an output end of a second power supply V2, an output end of the first comparator LT1 is connected to an input end of the logic processing unit 201; a second end of the sixth resistor R6 is connected to a negative pin of the second comparator LT2, a positive pin of the second comparator LT2 is connected to the output end of the second power supply V2, and an output end of the second comparator LT2 is connected to the input end of the logic processing unit 201.

The first comparator LT1 is configured to output a high level when the voltage difference output by the operational amplifier OP777 is higher than or equal to a reference voltage output by the second power supply V2, and output a low level when the voltage difference is lower than the reference voltage output by the second power supply V2. The second comparator LT2 is configured to output a high level when the voltage difference output by the operational amplifier OP777 is lower than the reference voltage output by the second power supply V2, and a low level when the voltage difference is higher than or equal to the reference voltage output by the second power supply V2. The reference voltage indicates the preset threshold for the difference in voltage output by the two battery modules 100. When the voltage difference is lower than the preset threshold, it indicates that the voltage difference output by the two battery modules 100 is relatively small and can supply power to the load simultaneously. When the voltage difference is higher than or equal to the preset threshold, it indicates that the voltage difference output by the two battery modules 100 is relatively large and cannot supply power to the load simultaneously, it is necessary to select the battery module 100 with a higher voltage to supply power to the load.

Scenario 1: assume that the voltage of the battery 1 (the battery module 100 corresponding to the comparison unit 203) is higher than that of the battery 2 (the other battery module 100), and the voltage difference is higher than the preset threshold (the reference voltage), then the voltage difference output by the operational amplifier OP777 is 0 (the voltage of the battery 2 minus the voltage of the battery 1 is negative, and is reflected as 0 in the circuit), then a voltage (the reference voltage) at the negative pin of the first comparator LT1 is higher than a voltage (the voltage difference) at the positive pin of the first comparator LT1, and the output “BAT2_V−BAT1_V” of the first comparator LT1 is a low level (i.e., V_{minus_out} corresponding to BAT2_V minus BAT1_V is 0, and the reference voltage is positive, Therefore, V_{minus_out} is lower than the reference voltage and the output is a low level). The output PA1 of the second comparator LT2 is a high level. Correspondingly, in the comparison unit 203 corresponding to the battery 2, the voltage difference output by the operational amplifier OP777 corresponding to the battery 2 is positive, then the negative pin (the reference voltage) of the first comparator LT1 of the comparison unit 203 corresponding to the battery 2 is lower than the positive pin (the voltage difference) of the first comparator LT1. The output “BAT1_V−BAT2_V” of the first comparator LT1 is a high level. Since the voltage difference is higher than the preset threshold, the output PA2 of the second comparator LT2 is a low level.

Scenario 2: assume that the voltage of the battery 1 (the battery module 100 corresponding to the comparison unit 203) is higher than that of the battery 2 (the other battery module 100), and the voltage difference is lower than the preset threshold (the reference voltage), the voltage difference output by the operational amplifier OP777 is 0 (the voltage of the battery 2 minus the voltage of the battery 1 is negative, and is reflected as 0 in the circuit), then the voltage (the reference voltage) at the negative pin of the first comparator LT1 is higher than the voltage (the voltage difference) at the positive pin of the first comparator LT1, the first comparator LT1 outputs a low level, and the output PA1 of the second comparator LT2 is a high level. Correspondingly, in the comparison unit 203 corresponding to the battery 2, the voltage difference output by the operational amplifier OP777 corresponding to the battery 2 is positive, then the negative pin (the reference voltage) of the first comparator LT1 of the comparison unit 203 corresponding to the battery 2 is lower than the positive pin (the voltage difference), and the first comparator LT1 outputs a high level. Since the voltage difference is lower than the preset threshold, the output PA2 of the second comparator LT2 is a high level.

In FIG. 4, only the comparison unit 203 with V_{minus_out} as its input is taken as an example, the comparison unit 203 with V_{u1_minus_out} as its input is similar to this comparison unit 203, and will not be repeated here.

Subsequently, the logic processing unit 201 determines an output of the enabling signal based on outputs of the first comparators LT1 and the second comparators LT2 of two comparison units 203. Continually take the above content as an example, when the outputs of the second comparators LT2 of the two comparison units 203 are both high levels, it corresponds to scenario 2 (the voltage difference being lower than the preset threshold), the logic processing unit 201 outputs enabling signals to both switch modules 300 corresponding to the two battery modules 100, to make the two switch modules 300 closed and achieve simultaneous power supply to the load by the two battery modules 100; when there is a low level in the outputs of the second comparators LT2 of the two comparison units 203, it corresponds to scenario 1 (the voltage difference being higher than the preset threshold), the logic processing unit 201 outputs an enabling signal to the switch module 300 corresponding to the battery module 100 with a higher voltage, so as to make the switch module 300 corresponding to the battery module 100 with the higher voltage closed and achieve power supply to the load solely by the battery module 100 with a higher output voltage.

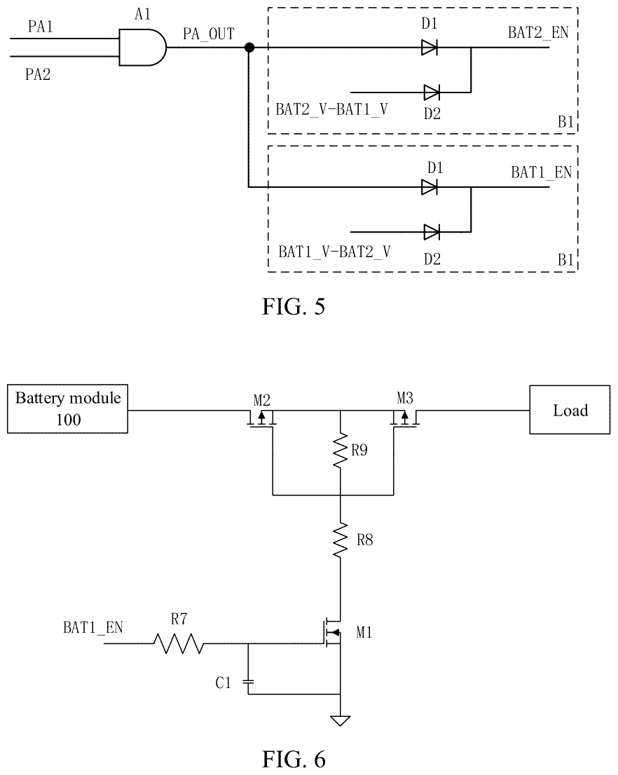

Below, a detailed introduction is provided in terms of how to achieve the above functions through the logic processing unit 201. FIG. 5 is a schematic structural diagram of yet another power supply circuit provided in the embodiment of the present disclosure. As shown in FIG. 5, the power supply circuit is based on the circuit structure shown in FIG. 2, the logic processing unit 201 includes: an AND gate subunit A1 and two OR gate subunits B1.

Among them, an input end of the AND gate subunit A1 is connected to two second comparators LT2, respectively; an output end of the AND gate subunit A1 is connected to input ends of the two OR gate subunits B1, respectively. The OR gate subunit B1 can be achieved by diodes connected in parallel. Take FIG. 2 as an example, the OR gate subunit B1 includes a first diode D1 and a second diode D2. An anode of the first diode D1 is connected to an output end of the AND gate subunit A1, a cathode of the first diode D1 is connected to a cathode of the second diode D2, an anode of the second diode D2 is connected to the output end of the first comparator LT1, and the cathodes of the first diode D1 and the second diode D2 are the output ends of the OR gate subunit B1, and output enabling signals.

The AND gate subunit A1 is configured to output a high level when the voltage difference is lower than the reference voltage, and a low level when the voltage difference is higher than the reference voltage. The OR gate subunit B1 is configured to output a high level when the voltage of the corresponding battery module 100 is higher than the voltage of the other battery module 100, and a low level when the voltage of the corresponding battery module 100 is lower than the voltage of the other battery module 100.

Continually refer to scenario 1 and scenario 2 in the above FIG. 4, when the outputs of the second comparators LT2 of the two comparison units 203 are both high levels, it corresponds to scenario 2 (the voltage difference being lower than the preset threshold), the outputs received by the AND gate subunit A1 from the two comparison units 203 are both high levels, therefore the output PA_OUT of the AND gate subunit A1 is also a high level; when there is a low level in the outputs of the second comparators LT2 of the two comparison units 203, it corresponds to scenario 1 (the voltage difference being higher than the preset threshold), for the outputs received by the AND gate subunit A1 from the two comparison units 203, one is a high level and the other is a low level, so the output PA_OUT of the AND gate subunit A1 is a low level.

In the scenario 2, the AND gate subunit A1 outputs the high level, each of the two OR gate subunits B1 has an input end that inputs the high level, thus regardless of the level situation at the other end, the two OR gate subunits B1 both output high levels to activate the outputs of the enabling signals BAT1_EN and BAT2_EN.

In the scenario 1, the AND gate subunit A1 outputs the low level, and the input ends of the two OR gate subunits B1 connected to the AND gate subunit A1 input the low level. The other input ends of the two OR gate subunits B1 are connected to the output ends of the first comparators LT1 of their respective comparison units 203, respectively. Furthermore, for the first comparators LT1 of the two comparison units 203, only one (i.e., the comparison unit 203 corresponding to a positive difference of the voltage difference between the battery 1 and the battery 2) outputs the high level and the other outputs the low level, therefore, only one of the two OR gate subunits B1 outputs the high level to activate the output of the enabling signal BAT1_EN or BAT2_EN, and the other OR gate subunit B1 outputs the low level to not activate the output of the enabling signal.

As can be seen from the above, the logic processing unit 201 can achieve the following functions, so as to control the battery module 100 that supplies power to the load based on the magnitude of the voltage difference:
1, when a voltage difference between two battery modules 100 is lower than a preset threshold, enabling signals are output to the switch modules 300 corresponding to the two battery modules 100 to make two switch modules 300 closed and achieve simultaneous power supply to the load by the two battery modules 100;
2, when the voltage difference between the two battery modules 100 is higher than the preset threshold, the logic processing unit 201 outputs an enabling signal to the switch module 300 corresponding to the battery module 100 with a higher voltage, in order to make the switch module 300 corresponding to the battery module 100 closed and achieve power supply to the load solely by the battery module 100 with a higher output voltage.

Below, the above switch module 300 is introduced. FIG. 6 is a schematic structural diagram of yet another power supply circuit provided in the embodiment of the present disclosure. As shown in FIG. 6, the power supply circuit is based on the circuit structure shown in FIG. 1, the switch module 300 includes: a first electronic switch, a second electronic switch, a third electronic switch, a seventh resistor R7, an eighth resistor R8, a ninth resistor R9, and a first capacitor C1.

A first end of the seventh resistor R7 is connected to an output end of the logic processing unit 201, a second end of the seventh resistor R7 is connected to a first pole of the first electronic switch and a first end of the first capacitor C1, respectively; a second pole of the first electronic switch is grounded, and a third pole of the first electronic switch is connected to a first end of the eighth resistor R8; a second end of the eighth resistor R8 is connected to a first pole of the second electronic switch, a first pole of the third electronic switch, and a first end of the ninth resistor R9, respectively; a second end of the ninth resistor R9 is connected to a second pole of the second electronic switch and a third pole of the third electronic switch, respectively; a third pole of the second electronic switch is connected to the output end of the battery module 100, and a second pole of the third electronic switch is connected to the load.

The first electronic switch is configured to be disconnected or closed based on an enabling signal output by the logic processing unit 201, and when the first electronic switch is closed, power is supplied to the load through the second pole of the third electronic switch. The above electronic switches can be composed of PMOS transistors, NMOS transistors, transistors, etc., which can be controlled by enabling signals.

In FIG. 6, an example is taken where the above first electronic switch is a NMOS transistor, and the above second and third electronic switches are PMOS transistors, the switch module 300 includes: a first MOS transistor M1, a second MOS transistor M2, a third MOS transistor M3, a seventh resistor R7, an eighth resistor R8, a ninth resistor R9, and a first capacitor C1.

Among them, the first end of the seventh resistor R7 is connected to the output end of the logic processing unit 201, the second end of the seventh resistor R7 is connected to a gate of the first MOS transistor M1 and the first end of the first capacitor C1, respectively; a drain of the first MOS transistor M1 is grounded, and a source of the first MOS transistor M1 is connected to the first end of the eighth resistor R8; the second end of the eighth resistor R8 is connected to a gate of the second MOS transistor M2, a gate of the third MOS transistor M3, and the first end of the ninth resistor R9, respectively; the second end of the ninth resistor R9 is connected to a drain of the second MOS transistor M2 and a source of the third MOS transistor M3, respectively; a source of the second MOS transistor M2 is connected to the output end of the battery module 100, and a drain of the third MOS transistor M3 is connected to the load.

The seventh resistor R7, the eighth resistor R8, and the ninth resistor R9 are all configured for voltage division, and the first capacitor C1 is configured to form a filter circuit. The first MOS transistor M1 is configured to be disconnected or closed based on the enabling signal output by the logic processing unit 201. When the first MOS transistor M1 is closed, power is supplied to the load through the drain of the third MOS transistor M3.

When the logic processing unit 201 outputs an enabling signal to the switch module 300, the enabling signal makes the gate of the first MOS transistor M1 conductive, thus enabling the first MOS transistor M1 to be conductive. After the first MOS transistor M1 becomes conductive, the source of the first MOS transistor M1 makes the gate of the second MOS transistor M2 and the gate of the third MOS transistor M3 conductive through the eighth resistor R8, so that the second MOS transistor M2 and the third MOS transistor M3 become conductive, in this way, the output of the battery module 100 corresponding to the switch module 300 is connected to the load through the conductive line where the second MOS transistor M2 and the third MOS transistor M3 are located, so as to supply power to the load.

In an implementation, the switch module 300 can also be an NMOS type electronic switch. The only difference between the NMOS type electronic switch and the PMOS type electronic switch shown in FIG. 6 is that their driving circuits are different. For the driving circuit, reference can be made to those in the prior art, which is not limited in the present disclosure.

According to the circuit structure provided in the embodiment of the present disclosure, the voltage difference between two battery modules 100 is obtained by the operation unit 202, and a magnitude relationship between the voltage difference and the preset threshold is compared based on the comparison unit 203. The logic processing unit 201 controls the closing or disconnecting of the switch modules 300 corresponding to the two battery modules 100 based on the magnitude relationship between the voltage difference and the preset threshold and the magnitude relationship of the output voltages of the two battery modules 100, to achieve the function of supplying power to the load with a battery or dual batteries. When the voltage difference between the dual battery modules 100 is large, only the battery module 100 with a higher voltage is configured to supply power. When the voltage difference is lower than the preset threshold, both of the dual battery modules 100 supply power, thereby improving the working time and current demands of the device, as well as improving a voltage stability and reducing power loss and cost. Besides, there are no restrictions on cell parameters and a protocol of the battery, so the solution has an advantage of strong compatibility.

In addition, when the above battery modules 100 are batteries, if one of the batteries is removed, due to parallel connection of the two batteries, a corresponding connection path of the removed battery is still in a conductive state. When this battery is reinserted in a case where the device is operated in a low voltage operating range, there will be a significant current back-flow, which would cause damage to the device and circuit. Therefore, the above issues can also be avoided by adding battery in-place detection switches.

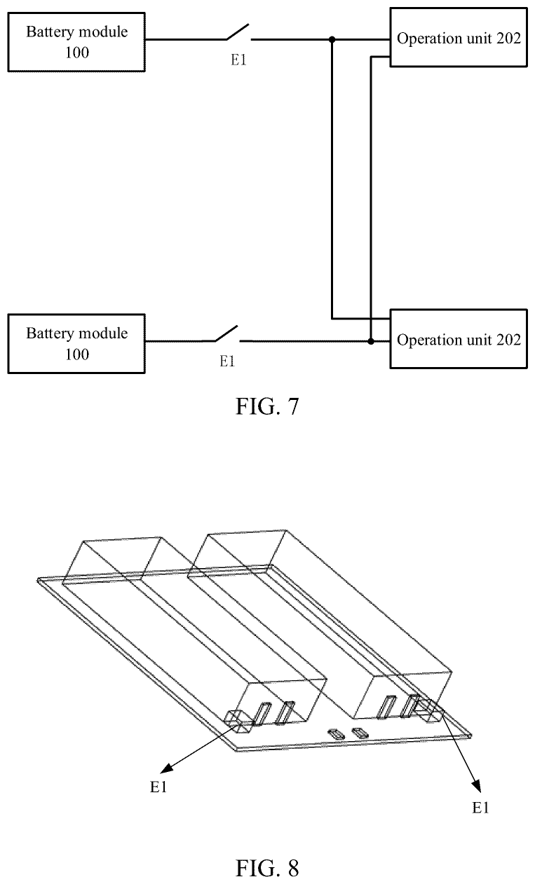

FIG. 7 is a schematic structural diagram of yet another power supply circuit provided in the embodiment of the present disclosure. As shown in FIG. 7, the power supply circuit is based on the circuit structure shown in FIG. 1, and further includes two battery in-place detection switches E1.

Among them, a first end of the battery in-place detection switch E1 is connected to an output end of a corresponding battery module 100, and a second end of the battery in-place detection switch E1 is connected to input ends of two operation units 202, respectively.

The battery in-place detection switch E1 is configured to detect whether the corresponding battery module 100 is in place, the battery in-place detection switch E1 is closed when the corresponding battery module 100 is in place, and the battery in-place detection switch E1 is disconnected when the corresponding battery module 100 is not in place. If the battery in-place detection switch E1 is closed, the corresponding connection path of the battery is conductive. If the battery in-place detection switch E1 is disconnected, the corresponding connection path of the battery is disconnected, thereby avoiding the significant current back-flow when the battery is reinserted.

The battery in-place detection switch E1 can be set at the installation position of the battery to facilitate the detection of whether the battery is in place. For example, the battery in-place detection switch E1 is a button type switch. When the battery is in place, it is installed in the battery groove and the battery will press down on the battery in-place detection switch E1 to make the battery in-place detection switch E1 closed; when the battery is removed, the battery in-place detection switch E1 bounces up due to lose of a squeezing force from the battery, thus causing the battery in-place detection switch E1 to be in the disconnected state. For example, the schematic diagram of the battery in-place detection switch E1 is shown in FIG. 8. FIG. 8 is a schematic structural diagram of a battery in-place detection switch E1 provided in the embodiment of the present disclosure.

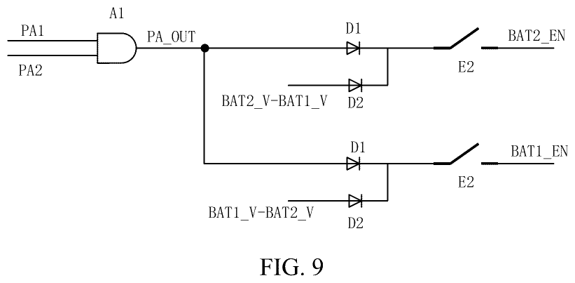

In one possible implementation, an impact of a charging port on the power supply circuit can also be considered. When the charging port is connected to a power supply to charge a battery, it is necessary to disconnect the path where the battery is located and only use another path to power the device. FIG. 9 is a schematic structural diagram of yet another power supply circuit provided in the embodiment of the present disclosure. As shown in FIG. 9, the power supply circuit further includes two power supply in-place detection switches E2.

Among them, a first end of the power supply in-place detection switch E2 is connected to an output end of the logic processing unit 201, and a second end of the power supply in-place detection switch E2 is connected to a control end of a corresponding switch module 300.

The power supply in-place detection switch E2 is configured to be disconnected when a third power supply for charging the corresponding battery module 100 is plugged in, and the power supply in-place detection switch E2 is configured to be closed when the corresponding battery module 100 does not detect that the third power supply is plugged in. If the power supply in-place detection switch E2 is closed, the corresponding connection path of the battery is conductive. If the power supply in-place detection switch E2 is disconnected, the corresponding connection path of the battery is disconnected, thereby avoiding impacts on the operation of the device due to the large current generated during charging of the battery.

The power supply in-place detection switch E2 can be set at the charging port of the device, and its setting method is not limited by the present disclosure. Reference can be made to any existing detection switch that detects whether the charging port is plugged into the power supply.

According to the structures provided in the embodiments of the present disclosure, by setting a battery in-place detection switch E1 and/or a power supply in-place detection switch E2, the following problems are avoided: significant current back-flow caused by reinserting the battery when it is not in place, and the impact of large current flow on the power supply circuit when the power supply charges the battery, thereby improving the safety and the stability of the power supply circuit.

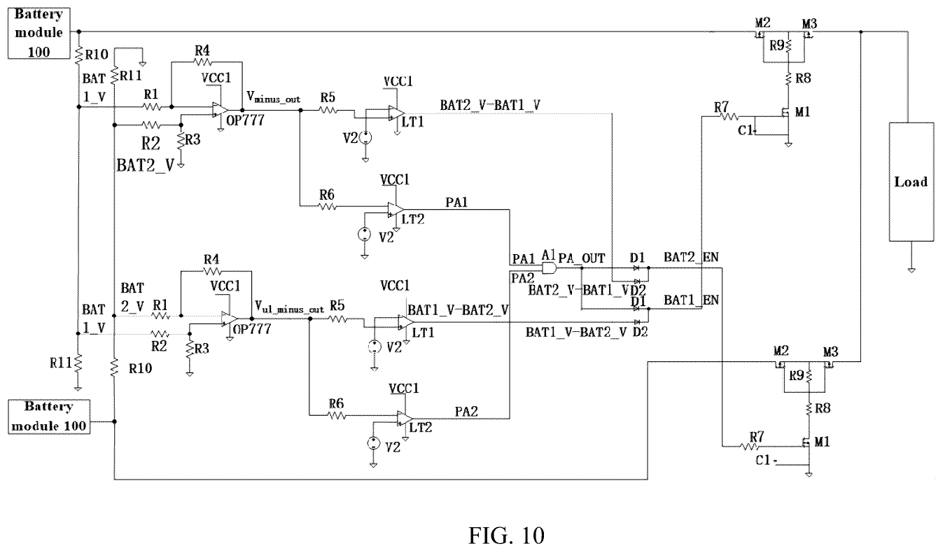

For the above embodiments, for ease of understanding, a complete circuit of the power supply circuit is shown in FIG. 10. FIG. 10 is a schematic structural diagram of yet another power supply circuit provided in the embodiment of the present disclosure. In FIG. 10, the tenth resistor R10 and the eleventh resistor R11 are further included. The tenth resistor R10 and the eleventh resistor R11 are configured to divide and sample the output voltage of each battery module 100, in order to help the processing module 200 to obtain the output voltage of the battery module 100.

On the other hand, an embodiment of the present disclosure also provides an electronic device, the electronic device includes a power supply circuit as described in any one of the above embodiments, which has a technical effect similar to the aforementioned power supply circuit and will not be further described here.

The person skilled in the art will easily come up with other embodiments of the present disclosure after considering the specification and practicing the disclosure disclosed herein. The present disclosure aims to cover any variations, uses, or adaptive changes of the present disclosure, which follow the general principles of the present disclosure and include common knowledge or conventional technical means in the technical field not disclosed in the present disclosure. The specification and embodiments are only deemed as examples, and the true scope and spirit of the present disclosure are indicated in the following claims.

It should be understood that the present disclosure is not limited to the precise structures described above and shown in the drawings, and various modifications and changes can be made without departing from its scope. The scope of the present disclosure is limited only by the accompanying claims.

What is claimed is:

1. A power supply circuit, wherein the power supply circuit comprises at least one sub power supply circuit, each sub power supply circuit comprises two battery modules, a processing module, and a switch module corresponding to each battery module;
an output end of the battery module is connected to one end of a corresponding switch module and one end of the processing module, respectively; the other end of the switch module is connected to a load, and the other end of the processing module is connected to a control end of the switch module; and
the processing module is configured to control, based on a voltage difference between the battery modules, the switch module of one of the battery modules or the switch modules of the two battery modules to be closed, in order to supply power to the load.

2. The circuit according to claim 1, wherein the processing module comprises a logic processing unit, an operation unit corresponding to each battery module, and a comparison unit;
an input end of the operation unit is connected to output ends of the two battery modules, respectively; an output end of the operation unit is connected to an input end of a corresponding comparison unit, and an output end of the comparison unit is connected to an input end of the logic processing unit;
the operation unit is configured to obtain the voltage difference between the battery modules;
the comparison unit is configured to judge a magnitude relationship between the voltage difference of the battery modules and a preset threshold; and
the logic processing unit is configured to control, based on the magnitude relationship between the voltage difference of the battery modules and the preset threshold, the switch module of one of the battery modules or the switch modules of the two battery modules to be closed, in order to supply power to the load.

3. The circuit according to claim 2, wherein the operation unit comprises a first resistor, a second resistor, a third resistor, a fourth resistor, and an operational amplifier;
a first end of the first resistor is connected to an output end of a battery module corresponding to the operation unit, and a second end of the first resistor is connected to a negative pin of the operational amplifier and a first end of the fourth resistor, respectively; a first end of the second resistor is connected to an output end of the other battery module, a second end of the second resistor is connected to a positive pin of the operational amplifier and a first end of the third resistor, respectively; a second end of the third resistor is grounded; a second end of the fourth resistor is connected to an output end of the operational amplifier; an anode of a power supply end of the operational amplifier is connected to an output end of a first power supply, and a cathode of the power supply end of the operational amplifier is grounded;
the operational amplifier is configured to obtain the voltage difference between the battery modules based on output voltages of the battery modules; and
the fourth resistor is configured to form a feedback resistor for the operation unit.

4. The circuit according to claim 2, wherein the comparison unit comprises a fifth resistor, a sixth resistor, a first comparator, and a second comparator;
a first end of the fifth resistor and a first end of the sixth resistor are connected to an output end of an operational amplifier, respectively; a second end of the fifth resistor is connected to a positive pin of the first comparator, a negative pin of the first comparator is connected to an output end of a second power supply, an output end of the first comparator is connected to an input end of the logic processing unit; a second end of the sixth resistor is connected to a negative pin of the second comparator, a positive pin of the second comparator is connected to the output end of the second power supply, and an output end of the second comparator is connected to the input end of the logic processing unit;
the first comparator is configured to output a high level when a voltage difference output by the operational amplifier is higher than or equal to a reference voltage output by the second power supply; and
the second comparator is configured to output a high level when the voltage difference output by the operational amplifier is lower than the reference voltage output by the second power supply.

5. The circuit according to claim 2, wherein the logic processing unit comprises an AND gate subunit and two OR gate subunits;
an input end of the AND gate subunit is connected to two second comparators, respectively; an output end of the AND gate subunit is connected to input ends of the two OR gate subunits, respectively;
the AND gate subunit is configured to output a high level when the voltage difference is lower than a reference voltage, and output a low level when the voltage difference is higher than the reference voltage;
the OR gate subunit is configured to output a high level when a voltage of a corresponding battery module is higher than a voltage of the other battery module, and output a low level when the voltage of the corresponding battery module is lower than the voltage of the other battery module.

6. The circuit according to claim 2, wherein the switch module comprises a first electronic switch, a second electronic switch, a third electronic switch, a seventh resistor, an eighth resistor, a ninth resistor, and a first capacitor;
a first end of the seventh resistor is connected to an output end of the logic processing unit, a second end of the seventh resistor is connected to a first pole of the first electronic switch and a first end of the first capacitor, respectively; a second pole of the first electronic switch is grounded, and a third pole of the first electronic switch is connected to a first end of the eighth resistor; a second end of the eighth resistor is connected to a first pole of the second electronic switch, a first pole of the third electronic switch, and a first end of the ninth resistor, respectively; a second end of the ninth resistor is connected to a second pole of the second electronic switch and a third pole of the third electronic switch, respectively; a third pole of the second electronic switch is connected to the output end of the battery module, and a second pole of the third electronic switch is connected to the load;
the first electronic switch is configured to be disconnected or closed based on an enabling signal output by the logic processing unit, and when the first electronic switch is closed, the power is supplied to the load through the second pole of the third electronic switch.

7. The circuit according to claim 6, wherein the electronic switch is a MOS transistor, a first pole of the electronic switch is a gate of the MOS transistor, a second pole of the electronic switch is a drain of the MOS transistor, and a third pole of the electronic switch is a source of the MOS transistor.

8. The circuit according to claim 1, further comprising two battery in-place detection switches;
a first end of the battery in-place detection switch is connected to an output end of a corresponding battery module, and a second end of the battery in-place detection switch is connected to input ends of two operation units, respectively;
the battery in-place detection switch is configured to detect whether the corresponding battery module is in place, wherein the battery in-place detection switch is closed when the corresponding battery module is in place, and the battery in-place detection switch is disconnected when the corresponding battery module is not in place.

9. The circuit according to claim 2, further comprising two battery in-place detection switches;
a first end of the battery in-place detection switch is connected to an output end of a corresponding battery module, and a second end of the battery in-place detection switch is connected to input ends of two operation units, respectively;
the battery in-place detection switch is configured to detect whether the corresponding battery module is in place, wherein the battery in-place detection switch is closed when the corresponding battery module is in place, and the battery in-place detection switch is disconnected when the corresponding battery module is not in place.

10. The circuit according to claim 3, further comprising two battery in-place detection switches;
a first end of the battery in-place detection switch is connected to an output end of a corresponding battery module, and a second end of the battery in-place detection switch is connected to input ends of two operation units, respectively;
the battery in-place detection switch is configured to detect whether the corresponding battery module is in place, wherein the battery in-place detection switch is closed when the corresponding battery module is in place, and the battery in-place detection switch is disconnected when the corresponding battery module is not in place.

11. The circuit according to claim 4, further comprising two battery in-place detection switches;
a first end of the battery in-place detection switch is connected to an output end of a corresponding battery module, and a second end of the battery in-place detection switch is connected to input ends of two operation units, respectively;
the battery in-place detection switch is configured to detect whether the corresponding battery module is in place, wherein the battery in-place detection switch is closed when the corresponding battery module is in place, and the battery in-place detection switch is disconnected when the corresponding battery module is not in place.

12. The circuit according to claim 5, further comprising two battery in-place detection switches;
a first end of the battery in-place detection switch is connected to an output end of a corresponding battery module, and a second end of the battery in-place detection switch is connected to input ends of two operation units, respectively;
the battery in-place detection switch is configured to detect whether the corresponding battery module is in place, wherein the battery in-place detection switch is closed when the corresponding battery module is in place, and the battery in-place detection switch is disconnected when the corresponding battery module is not in place.

13. The circuit according to claim 6, further comprising two battery in-place detection switches;
a first end of the battery in-place detection switch is connected to an output end of a corresponding battery module, and a second end of the battery in-place detection switch is connected to input ends of two operation units, respectively;
the battery in-place detection switch is configured to detect whether the corresponding battery module is in place, wherein the battery in-place detection switch is closed when the corresponding battery module is in place, and the battery in-place detection switch is disconnected when the corresponding battery module is not in place.

14. The circuit according to claim 1, further comprising two power supply in-place detection switches;
a first end of the power supply in-place detection switch is connected to an output end of the logic processing unit, and a second end of the power supply in-place detection switch is connected to a control end of a corresponding switch module;
the power supply in-place detection switch is configured to be disconnected when a third power supply for charging the corresponding battery module is plugged in, and the power supply in-place detection switch is configured to be closed when the corresponding battery module does not detect that the third power supply is plugged in.

15. The circuit according to claim 2, further comprising two power supply in-place detection switches;
a first end of the power supply in-place detection switch is connected to an output end of the logic processing unit, and a second end of the power supply in-place detection switch is connected to a control end of a corresponding switch module;
the power supply in-place detection switch is configured to be disconnected when a third power supply for charging the corresponding battery module is plugged in, and the power supply in-place detection switch is configured to be closed when the corresponding battery module does not detect that the third power supply is plugged in.

16. The circuit according to claim 3, further comprising two power supply in-place detection switches;
a first end of the power supply in-place detection switch is connected to an output end of the logic processing unit, and a second end of the power supply in-place detection switch is connected to a control end of a corresponding switch module;
the power supply in-place detection switch is configured to be disconnected when a third power supply for charging the corresponding battery module is plugged in, and the power supply in-place detection switch is configured to be closed when the corresponding battery module does not detect that the third power supply is plugged in.

17. The circuit according to claim 4, further comprising two power supply in-place detection switches;
a first end of the power supply in-place detection switch is connected to an output end of the logic processing unit, and a second end of the power supply in-place detection switch is connected to a control end of a corresponding switch module;
the power supply in-place detection switch is configured to be disconnected when a third power supply for charging the corresponding battery module is plugged in, and the power supply in-place detection switch is configured to be closed when the corresponding battery module does not detect that the third power supply is plugged in.

18. The circuit according to claim 5, further comprising two power supply in-place detection switches;
a first end of the power supply in-place detection switch is connected to an output end of the logic processing unit, and a second end of the power supply in-place detection switch is connected to a control end of a corresponding switch module;
the power supply in-place detection switch is configured to be disconnected when a third power supply for charging the corresponding battery module is plugged in, and the power supply in-place detection switch is configured to be closed when the corresponding battery module does not detect that the third power supply is plugged in.

19. The circuit according to claim 6, further comprising two power supply in-place detection switches;
a first end of the power supply in-place detection switch is connected to an output end of the logic processing unit, and a second end of the power supply in-place detection switch is connected to a control end of a corresponding switch module;
the power supply in-place detection switch is configured to be disconnected when a third power supply for charging the corresponding battery module is plugged in, and the power supply in-place detection switch is configured to be closed when the corresponding battery module does not detect that the third power supply is plugged in.

20. An electric device, wherein the electric device comprises the power supply circuit according to claim 1.
